(19) United States
(12) Patent Application Publication
(10) Pub. No.: US 2008/0291314 A1
(43) Pub. Date: Nov. 27, 2008

(54) IMAGING DEVICE WITH AUTO-FOCUS

(75) Inventors: JOHN C. PINCENTI, DES PLAINES, IL (US); KEVIN W. JOHNSON, MUNDELEIN, IL (US); DOINA I. PETRESCU, VERNON HILLS, IL (US); JASON R. RUKES, GURNEE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/753,701

(22) Filed: May 25, 2007

(51) Int. Cl. H04N 5/335

(52) U.S. Cl. 348/311; 348/E05.091

(57) ABSTRACT

A handheld portable imaging device (100) including a first array of pixels and a second array of pixels embedded within the first array. A processor coupled to the first and second arrays processes data read from first array independently of data read from the second array. In one embodiment, data read from the first array is processed as an image, and data read from the second array is processed relatively quickly for controlling a lens actuator that focuses an image on the first array. In another embodiment, the data from the second array is used to stabilize an image captured by the first array.

The present disclosure relates generally to imaging devices, and more particularly to an imaging array having an auto-focus or features suitable for use in portable devices.

### BACKGROUND

Imaging devices such as CMOS and CCD based cameras in portable devices are well known. In portable applications, for example, in cellular telephones, it is often necessary for the camera to be relatively small, inexpensive and robust. These design constraints usually result in relatively poor image quality, at least with respect to that provided by dedicated and professional digital cameras. Consumer demand imaging features having improved performance in mobile devices and other portable products without a substantial cost increase.

The imagers provided in many low cost applications, including mobile communication devices, comprise a fixed focus lens capable of rendering marginally acceptable images over a relatively limited range between approximately 60 cm and infinity. Fixed focus lenses however are unsuitable for business card imaging and other near field applications. Thus it is desirable to provide an auto-focusing lens in these and other low cost imaging applications.

Manual lens focusing requires some skill and is not generally appealing to most consumers. Auto-focus lenses that render clear images over a wide range of distances and that are suitable for mobile communication device applications are available, but these imaging devices require substantial time to focus automatically. To achieve auto-focus, an iterative process of moving the lens to a new position and examining the image is performed over a number of frames until an optimal position is found. The frame rate is typically 1/15 of a second and a typical algorithm iterates over about 15 frames. Thus the auto-focus process may require 1 or more seconds before an image may be captured. The auto-focus time may be reduced by reducing the number of frames, but with a loss of accuracy. Moreover, this focus delay is not limited to the low cost applications discussed above. The excessive auto-focus time also makes existing auto-focus algorithms unsuitable for video-capture where the scene varies continuously.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a prior art active interval containing a sequence of packets separated by an inter-arrival time.

FIG. 2 illustrates an array of light pixels coupled to a processor.

FIG. 3 illustrates an alternative pixel array.

FIG. 4 illustrates a process in an imaging device.

FIG. 5 illustrates another processing in an imaging device.

### DETAILED DESCRIPTION

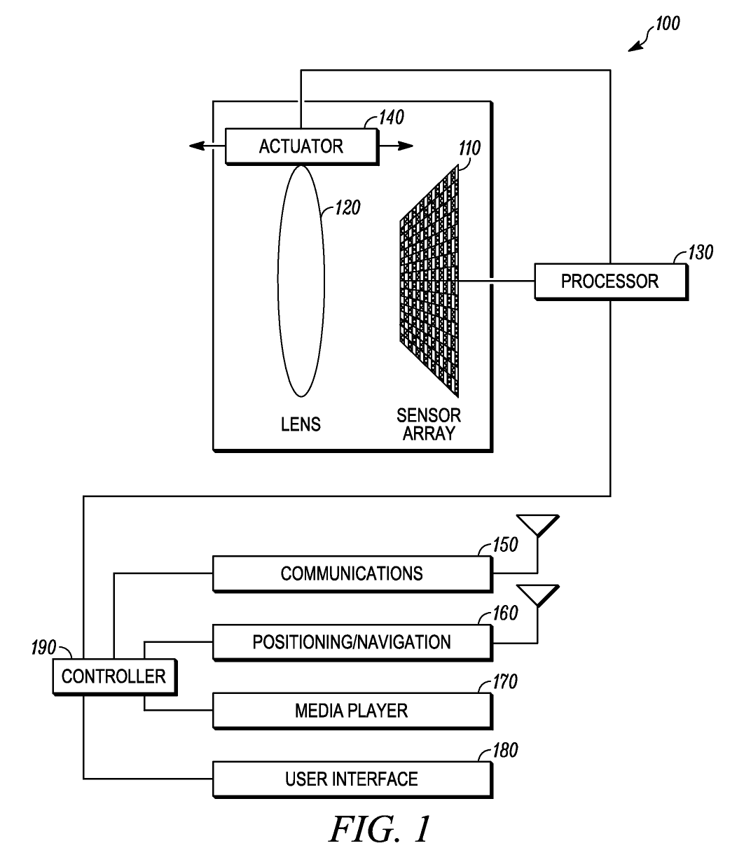

The disclosure relates to portable imaging devices including cameras and video recorders, which may be embodied as dedicated devices or as a feature integrated with a device primarily used for another purpose. FIG. 1 illustrates an exemplary portable imaging device 100 comprising a sensor array 110 and a lens 120 focused on the array. While FIG. 1 illustrates only a single lens, more generally, the lens 120 is representative of a system of multiple lenses capable of focusing the image. The array is discussed more fully below, though the array generally includes an output coupled to a processor 130 capable of processing still or video image data captured by the array. The processor may process and generate image information for display on a user interface of the device and/or generate image files based upon data captured by the array for playback and storage in memory as is known generally. The exemplary device also includes a lens actuator 140 for focusing the lens as discussed further below. Other embodiments do not necessarily include a lens actuator.

The portable imaging device may be embodied as a stand-alone digital camera or video recorder or it may be integrated with a device that performs other features and functions. In FIG. 1, the exemplary device 100 in comprises a wireless communications module 150. The communications module may be compliant with one or more of a variety of wireless communication protocols, including but not limited to cellular, LAN, and WiMAX among others. The device 100 also includes a positioning and navigation module 160, for example, a satellite positioning system (SPS) based receiver that computes location and in some embodiments performs navigation and routing functions, the results of which may be displayed at a user interface of the device. The positioning and navigation module may also be interoperable with the wireless communications module to send and receive location information to and from the network as is known generally. The device 100 also includes a media player 170 for playing content including audio and/or video content at a user interface 180 of the device. The media player may be used to view images captured with the imaging device. The device 100 does not necessarily include all of the features or modules illustrated and may include various combinations of these and other features.

In FIG, 1, the exemplary device comprises a controller 190 that integrates and controls the various modules including the imaging device. In an alternative embodiment, the functionality of the imaging processor and the controller may be integrated in a single device. Moreover, while the modules are illustrated as discrete components, the functionality performed by each module may be integrated in whole or in part with the functionality of one or more other modules or with the functionality of the controller.

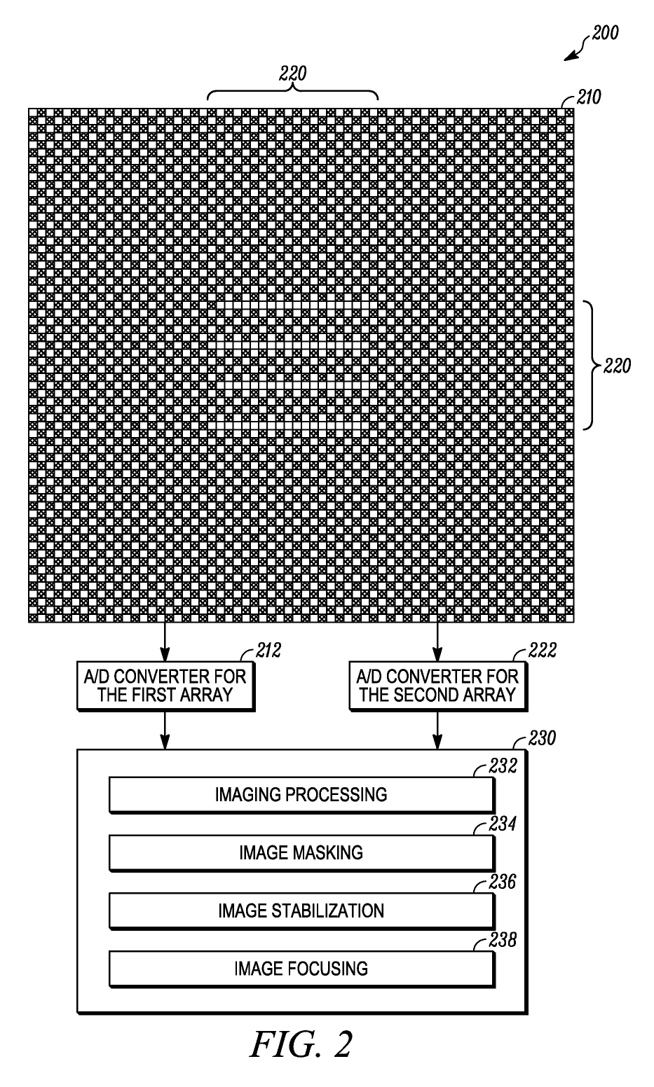

FIG. 2 illustrates an exemplary array 200 of light sensitive pixels for use in an imaging device. The term “light sensitive” as used in the characterization of the pixels array is not intended to be limited to the capture of visible light. Thus array of light sensitive pixels is more generally capable of capturing light or radiation in other, non-visible portions of the electromagnetic spectrum including but not limited to the infrared portion thereof. In one embodiment, the pixel array is a CMOS device and in another embodiment the pixel array is a CCD device. In other embodiments, the pixel array may be comprised of other materials or technologies. Thus the instant disclosure is not intended to be limited to CCD and CMOS type sensors.

In one embodiment, the first array is larger than the second array. In FIG. 2, for example, the array comprises a relatively large two-dimensional array of light sensitive pixels 210 and a second array of light sensitive pixels (illustrated as contrasting white pixels) 220 embedded within the two-dimensional array. In FIG. 2, the second array is characterized by 4 rows and multiple columns (4×n array), wherein the second array is smaller than the two-dimensional array. Particularly, the second array has fewer pixels than the first array. In other embodiments, however, the second array may have different dimensions, for example, a single dimension array. Also, in FIG. 2, the second array is embedded within a portion of the first array. In other embodiments, however, the second array may be embedded along an upper or lower edge of the first array or along one or both sides of the array. In some embodiments, the second array is embedded along both vertical and horizontal edges of the array.

In one embodiment, the pixels of the first array are different than the pixels of the second array. For example, the pixels of the first array may have a color filter associated therewith, wherein the pixels of the second array are devoid of a color filter. In one filter implementation, the color filter is embodied as a red, green and blue (RGB) filters that form an array of color pixels, wherein each color pixel comprises two or more sub-pixels. In other embodiments, the filter may be a single color or a non-color filter.

In another embodiment, the pixels of the first array are less light sensitive than pixels of the second array. The difference in sensitivity of the pixels in the first and second arrays may be based upon on size of the pixels, the silicon process used to form the pixels, among other characteristics of the pixel or the materials from which the pixels are formed and combinations thereof. Eliminating the color filter on pixels of the second array will also make the pixels more light sensitive. The pixels of the second array may be different from the pixels of the first array for various other reasons, for example, based on size and/or material characteristics.

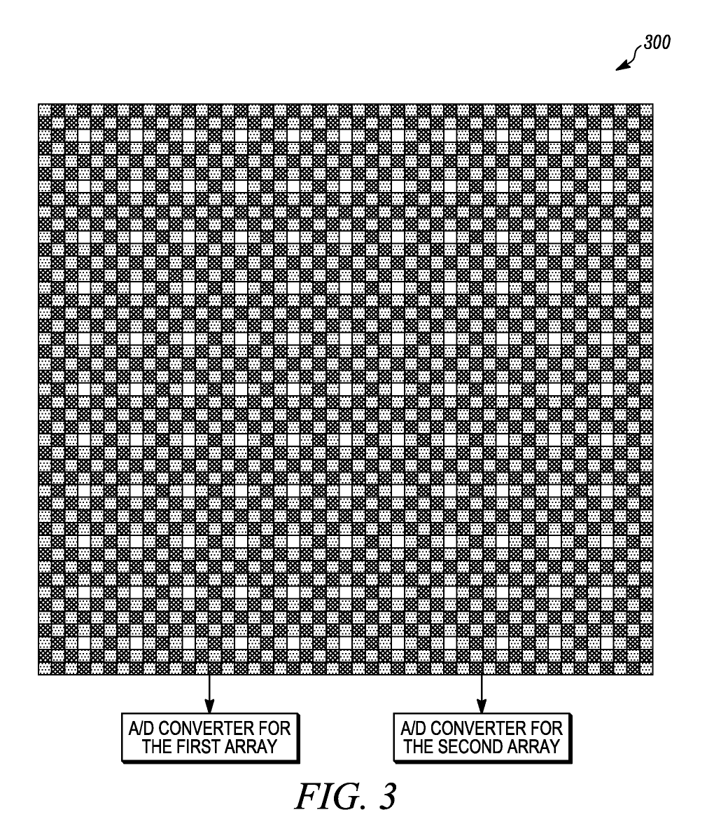

FIG. 3 illustrates an alternative pixel array 300 wherein the color filter is removed from every other blue pixel in both the horizontal and vertical directions. In this alternative embodiment, the second array comprises the pixels from which the blue filter has been removed. In other embodiments, the second array may be comprised of pixels from which other color filters have been removed, for example, the white sub-pixels in a RGBW pixel. Alternatively, the second array may be comprised of pixels specifically designed into the array to avoid removal of sub-pixels in the array.

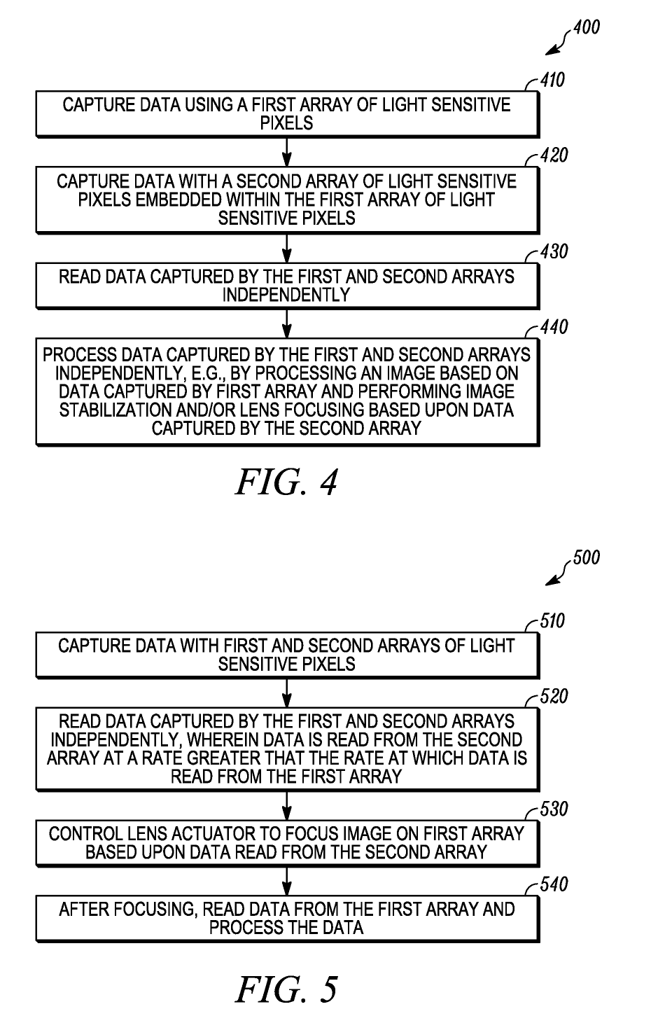

In the portable imaging device process flow schematic of FIG. 4, at 410, data is captured by a first array of light sensitive pixels. At 420 data is captured with a second array of light sensitive pixels that are embedded within the first array of light sensitive pixels. While FIG. 2 suggests that the capture of data by the first and second arrays occurs sequentially, these arrays capture data upon exposing the arrays to an image, which may occur substantially simultaneously. In the case of a still camera application, the arrays are exposed to the image upon opening a shutter. For video imaging applications, the first and second arrays are exposed to images upon activating the recording function, assuming no obstruction from a lens cap or cover. Thus the capture of data by the arrays occurs substantially simultaneously, assuming that both arrays are exposed to the image concurrently. In FIG. 2, data is captured by the first and second arrays 210 and 220.

In FIG. 4, at 430, data is read from the first array at a different rate than which data is read from the second array. In FIG. 2, data is read from the first and seconds arrays 210, 220 by a processor 230. In one implementation, the processor is configured to read data from first and second arrays of light sensitive pixels independently. In FIG. 2, to facilitate the independent reading of data captured by the first and second arrays, the first array is coupled to the processor by a first A/D converter 212 and the second array is coupled to the processor by a second A/D converter 222. Thus the processor may read data from the first and second arrays at different rates. For example, the data captured by the second array 220 may be read by the processor more quickly than data captured by the first array by virtue of the relatively small size of the second array. More particularly, the processor may independently control the frame rate, integration time, vertical and horizontal blanking and other timing characteristics associated with the reading of data from the first and second arrays.

In FIG. 4 at 440, in some embodiments, the processor processes data captured by the first array of light sensitive pixels independently from the processing of data captured by the second array of light sensitive pixels. Examples of independent processing of the data are discussed further below.

In one embodiment, the processor processes a still of video image based upon data captured by the first array. In FIG. 2, the processor 230 includes an image processing module 232 for processing the image. The image processing module is most typically implemented as a software application executed by the processor or controller. These and other applications executed by the processor are typically stored in a memory device not shown but well known to those having ordinary skill in the art. In one embodiment, the processor masks the pixels of the second array embedded in the first array when processing an image based upon the data captured by the first array, as discussed further below. The image masking is typically performed by software processes illustrated schematically by the image masking module 234 of FIG. 2.

As suggested, the pixels of the first array are typically used to render an image via image signal processing. Due to the different characteristics of the first and second arrays, the pixels of the second array can not be used in the rendering of the image without additional signal processing. Without additional signal processing, the pixels of the second array would result in an undesirable image. Pixel masking is a process by which the presence of the second array is removed from the final rendered image. At least one way of doing this, is by first ignoring the data from the pixels of the second array during the image rendering process. This process alone would leave missing data in the final rendered image. Therefore, data from pixels in the first array that neighbor the pixels of the second array are used to fill in the missing pixels, for example, using interpolation or extrapolation algorithms. Proper placement of the pixels of the second array may also reduce the affect of the second array on the image captured by the first array. Thus with optimized pixel placement and/or selection and a properly designed signal processing algorithm, the presence of the second array can be made unperceivable in images captured by the first array.

In another embodiment, the processor stabilizes an image based upon data captured by the first array wherein the stabilization is based upon data read from the second array. Image stabilization may be performed by a stabilization algorithm executed by the processor and illustrated schematically as the stabilization module 236 in FIG. 2. Image stabilization techniques are well known generally by those having ordinary skill in the art and thus are not discussed further herein. In this embodiment, the processor independently processes data captured by the first and second arrays by processing an image based upon data captured by the first array and by stabilizing the image based upon data captured by the second array. The efficacy of the image stabilization may be improved be reading data captured by the second array at a higher rate than the rate at which data is read from the first array, as discussed above.

In another embodiment, the processor independently processes the data captured by the first and second arrays by focusing an image on the first array based upon data captured by the second array and by processing the focused image based upon data captured by the second array after focusing. In FIG. 1, the image focusing is performed by positioning the lens 120 with the actuator 140 that positions the lens until the image is focused on the first array. Image focusing may be performed by a focusing algorithm executed by the processor and illustrated schematically as the focusing module 238 in FIG. 4. Image focusing algorithms are known generally and thus not discussed further herein. In some embodiments, the processor may also stabilize the focused image based upon the data captured by the second array.

The image focus time may be reduced be reading data captured by the second array at a higher rate than the rate at which data is read from the first array. The relatively small size of the second array facilitates reading data of the second array more quickly than reading data captured by the first, relatively large array. According to this embodiment, auto-focusing is enhanced by the ability of the focusing algorithm to obtain imaging statistics at a rate significantly higher than the imager frame rate.

FIG. 5 illustrates a lens focusing and imaging process 500 in an imaging device comprising an array including a first array and a second relatively small array embedded within the first array, for example, the array 200 of FIG. 2 or the array 300 of FIG. 3. In FIG. 5, at 510, data is captured by the first and second arrays. At 520, data captured by the second smaller array is read at a relatively high frame rate by a processor, for example, the processor 230 in FIG. 2. In FIG. 5, at 530, an image is focused on the first, larger array based upon the data read from the second smaller array. For example, in FIG. 1, the processor 130 executes an image focusing algorithm used to control the actuator 140 for positioning the lens 120. The data read from the second array is provided as an input to the focusing algorithm. Algorithms for operating a lens actuator based on data read from an imaging array are well known. Because the processor can read data from the second array relatively quickly, due to its small size relative to the first array, the image focusing time is reduced substantially. Moreover, the reduction in the image focusing time makes it possible to continuously auto-focus the image during video recording. In FIG. 5, at 540, after focusing the image, the processor reads the data from the first array and processes the data, for example to display and/or generate an image or video file. As suggested above, in some embodiments the data read from the second smaller array may also be processed for purposes other than or in addition to image focusing, for example, for image stabilization.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiment but by the appended claims.

What is claimed is:

1. A handheld portable imaging device comprising:
a first array of light sensitive pixels;
a second array of light sensitive pixels embedded within the first array;
a processor coupled to the first array and to the second array,
the processor configured to process data read from second array processed independently from data read from the first array.

2. The imaging device of claim 1,
the processor configured to process an image captured by the first array,
the processor configured to stabilize the image captured by the first array based on data read from the second array.

3. The imaging device of claim 1, further comprising
a lens-positioning actuator;
the processor having a control output coupled to the lens positioning actuator, the processor includes a lens-positioning module configured to control the actuator based on data read from the second array,
the processor includes an image processing module configured to process an image captured by the first array.

4. The imaging device of claim 1,
the processor includes an image processing module configured to process an image captured by the first array,
the processor includes a pixel masking module configured to mask pixels of the second array when processing the image captured by the first array.

5. The imaging device of claim 1, the pixels of the first array different than the pixels of the second array.

6. The imaging device 5, the pixels of the first array have a color filter associated therewith and the pixels of the second array are devoid of a color filter.

7. The imaging device of claim 5, the pixels of the first array are less light sensitive than pixels of the second array.

8. The imaging device of claim 1,
an output of the first array coupled to an input of the processor by a first A/D converter, an input of the second array coupled to an input of the processor by a second A/D converter,
the processor configured to read data from first array at a rate different than the rate at which data is read from the second array.

9. The imaging device of claim 1, the first array is larger than the second array.

10. A method in a handheld portable imaging device, the method comprising:
capturing data with a first array of light sensitive pixels;
capturing data with a second array of light sensitive pixels, the second array of light sensitive pixels embedded within the first array of light sensitive pixels;
processing data captured by the first array of light sensitive pixels independently of the processing of data captured by the second array of light sensitive pixels.

11. The method of claim 10, processing data read from first and second arrays of light sensitive pixels includes processing an image based on the data read from the first array of light sensitive pixels and stabilizing the image based on data read from the second array of light sensitive pixels.

12. The method of claim 10, processing data read from first and second arrays of light sensitive pixels includes controlling a lens-positioning actuator based on data read from the second array of light sensitive pixels, and processing an image based on data read from the first array of light sensitive pixels.

13. The method of claim 10, processing data read from first array of light sensitive pixels includes processing an image based on data read from the first array of light sensitive pixels and masking pixels of the second array when processing the image.

14. The method of claim 10, reading the data from the first array of light sensitive pixels at a rate different than a rate at which data is read from the second array of light sensitive pixels.

15. The method of claim 10, capturing data with the first and second arrays of light sensitive pixels wherein the pixels of the first and second arrays have different sensitivities.

16. A handheld portable imaging device comprising:
a first array of light sensitive pixels;
a second array of light sensitive pixels embedded within the first array,
the first array is larger than the second array;
a processor coupled to the first array and to the second array,
the processor configured to read data from first array independently of data read from the second array.

17. The imaging device of claim 16,
an output of the first array coupled to an input of the processor by a first A/D converter, an input of the second array coupled to an input of the processor by a second A/D converter,
the processor configured to read data from first array at a first frame rate and to read data from the second array at a second frame rate greater than the first frame rate.
